(19) United States
(12) Patent Application Publication
(10) Pub. No.: US 2009/0147925 A1
(43) Pub. Date: Jun. 11, 2009

(54) CALIBRATION TOOL AND A METHOD OF CALIBRATING AN IMAGING SYSTEM

(75) Inventors: Mattieu Stefan De Villiers, Cape Town (ZA); Carlos Manuel De Seabra Sousa, Johannesburg (ZA); Johannes Hermanus Potgieter, Midrand (ZA)

Correspondence Address: SCULLY SCOTT MURPHY & PRESSER, PC, 400 GARDEN CITY PLAZA, SUITE 300, GARDEN CITY, NY, 11530, US

(73) Assignee: LODOX SYSTEMS (PROPRIETARY) LIMITED, SANDTON (ZA)

(21) Appl. No.: 11/918,515

(22) PCT Filed: Apr. 13, 2006
(86) PCT No.: PCT/IB2006/000856

§ 371 Date: May 9, 2008

(30) Foreign Application Priority Data
Apr. 13, 2005 (ZA) 2005/02962

(51) Int. Cl. G01D 18/00

(52) U.S. Cl. 378/207

(57) ABSTRACT

A method of calibrating an imaging system includes placing a calibration tool in a position relative to the imaging system where an object to be imaged in normal use of the system would be placed. An image of the calibration tool is taken and the resulting image is used to calibrate the imaging system.

### BACKGROUND OF THE INVENTION

This invention relates to a calibration tool and to a method of calibrating an imaging system.

Two basic types of imaging apparatus for human and animal diagnosis are known. The first uses an x-ray source which illuminates the whole of the area under examination. For human application, this is often referred to as full field, or when the whole body is to be examined, a whole body examination.

The second type of apparatus is a scanning x-ray system for which the x-ray source and the detector are moved relative to the subject under examination, in order to generate a composite image of the subject. Such a system is disclosed in International patent application no. WO 00/53093.

The x-ray detector system may be conventional film, or can be scintillator arrays optically linked to charge coupled devices (CCD's). The latter is the system used in the scanning system described in the above mentioned International patent application, in which the x-ray source is mounted on one end of a C-shaped arm, and the scintillator arrays are mounted on the opposite end of the C-arm. In such a scanning system, it is preferable that the x-rays are highly collimated by a single slit, the resulting x-ray beam is a narrow “fan-beam” of x-rays of typical width of 3 to 6 mm, and which extends the full width of the scanning system, again typically 680 mm.

The present invention provides a calibration tool for an imaging system and a method of calibrating an imaging system

### SUMMARY OF THE INVENTION

According to a first aspect of the invention there is provided a method of calibrating an imaging system, the method including:
placing a calibration tool in a position relative to the imaging system where an object to be imaged in normal use of the system would be placed;
capturing an image of the calibration tool; and
using the resulting image of the calibration tool to calibrate the imaging system.

The resulting image of the calibration tool may be stored for future use.

In one example, the calibration includes column alignment and column pitch spacing.

The stored image of the calibration tool may be used to test the imaging performance of the imaging system over time by taking images of the calibration tool and comparing these to the stored image of the calibration tool.

The image performance of the calibration tool may be used to test at least one of the following characteristics of the system: signal to noise ratio (SNR), modulation transfer function (MTF), noise power spectrum (NPS) and notional quantum efficiency (notional DQE).

The imaging system is typically a radiography imaging system.

According to a second aspect of the invention there is provided a calibration tool including:
at least one straight edge to align the tool, the straight edge being perpendicular to a scanning direction of an imaging system when the system is in use; and
at least one skew edge inclined from the perpendicular to the scanning direction.

The tool may have a portion of varying thickness being a step portion.

The tool may include slots or holes perpendicular to the skew edge, and centered over the x-ray detection elements when in use.

The tool may be partly made from uniform absorption material and partly made from highly x-ray absorbing material.

The step portion may be made from uniform absorption material and a portion near the skew edge may be made from x-ray absorbing material.

The step portion may have sections of differing thickness perpendicular to an x-ray beam and oriented parallel to the scanning direction of the system, when the tool is in use.

### BRIEF DESCRIPTION OF THE DRAWINGS

FIG. 1 is a pictorial view of a radiological scanning x-ray system;

FIG. 2 is an example embodiment of a calibration tool;

FIG. 3 shows the calibration tool of FIG. 2 in use in a radiography system;

FIG. 4 shows an unprocessed scan of the calibration tool of FIG. 2;

FIG. 5 shows a processed scan of the calibration tool of FIG. 4;

FIG. 6 is a graph of the detected position of the straight edge of the calibration tool;

FIG. 7 is a graph of the detected position of the skew edge of the calibration tool;

FIG. 8 is a graph of the detected position of the skew edge error of the calibration tool;

FIG. 9 is a pictogram indicating how the overlap is determined;

FIG. 10 is a graph of the camera edges showing the overlap determination; and

FIG. 11 is a graph of the cubic spline fitted curve for pitch correction.

### DESCRIPTION OF AN EMBODIMENT

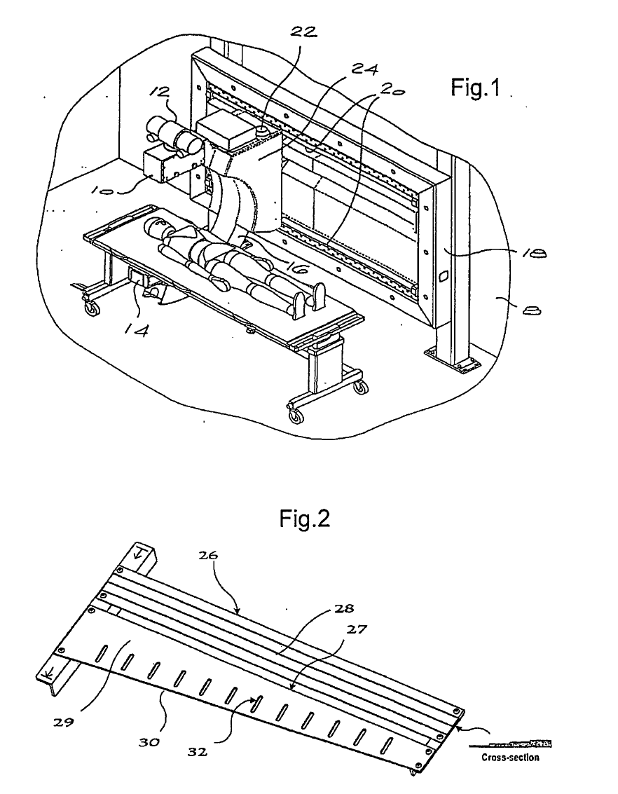

FIG. 1 shows an example of a radiological scanning apparatus. The apparatus comprises a head 10 containing an X-ray source 12 which emits a narrow, fanned beam of X-rays towards a detector unit 14. The X-ray source 12 and the detector unit 14 are supported at opposite ends of a curved arm 16 which is generally semi-circular or C-shaped.

A frame 18 mounted on a wall 8 or another fixed structure defines a pair of rails 20 with which a motorised drive mechanism 22 engages to drive the arm linearly back and forth in a first, axial direction of movement. This corresponds to the direction of scanning in use. In addition, the drive mechanism comprises a housing 24 in which the arm 16 is movable by the drive mechanism in order to cause the X-ray source and the detector to rotate about an axis parallel with the scanning direction of the mechanism.

A typical application of the imaging apparatus of the invention is in a radiological installation which will include positioning consoles by means of which an operator can set up the required viewing parameters (for example, the angle of the arm 16, start and stop positions, and the width of the area to be X-rayed) and a main operator console which is used by the operator to set up the required radiographic procedure. The imaging apparatus is operated to perform a scan of a subject supported on a specialised trolley or gurney

The apparatus described above is generally similar to that described in International patent application no. WO 00/53093, the contents of which are incorporated herein by reference.

It will be appreciated that while an example methodology will be described in the context of the above imaging system, the methodology finds application in other imaging systems.

In any event, referring back to the FIG. 1, the X-ray source (tube) 12 emits a low-dose collimated fan-beam of X-rays. The X-ray detector unit 14 fixed to the other end of the C-arm 16 comprises a set of scintillator arrays optically linked to respective charge-coupled devices (CCDs). An image is acquired by linearly scanning the C-arm over the length of the subject (patient) 32 with the X-ray source active, whilst continuously reading the outputs of the detector unit in a mode analogous to “scrolling”, thus building up a composite image.

In an example system, the individual pixels of the detector unit have a 60-micron size, providing up to 14336 elements along the length of the detector. This defines the width of the area to be scanned. Spatial resolutions of 1.04 to 8.33 line pairs per millimeter (lp/mm) are selectable in discrete steps. The system can record 14 bits of contrast resolution (>16383 grey scales) which compares favorably to the typically 1000 grey scales that can be detected on a conventional x-ray film under ideal viewing conditions. The C-arm is able to rotate axially around the patient to any angle up to 90 degrees, permitting horizontal-beam, shoot-through lateral, erect and oblique views.

The C-arm travels at speeds of up to 144 or 200 mm per second. The device is thus able to rapidly acquire images of part or all of the body of a patient, with a full body scan requiring 13 seconds (medical application) and 10 seconds for the screening application; and with smaller areas requiring proportionately less time.

As indicated above, the system makes use of the technological principle sometimes referred to as “slit (or slot) scanning” and in this case, specifically “linear slit scanning”. The detector is based on CCD technology running in the so-called “drift scanning”, alternatively “TDI” (time-division integration) mode.

The X-rays emitted by the source 12 are highly collimated by a single slit that irradiates the detector with a narrow “fan beam” of x-rays. The fan beam is “narrow” (3 mm-6 mm thick for medical) in the scanning direction and “wide” (˜696 mm—medical application/˜812 mm—screening application) in a direction transverse to the scanning direction. For applications where a fixed slit/slot is used the fan beam thickness is optimized for the application, example 10-11 mm for the screening application.

Referring to FIG. 2, a calibration tool 26 for an imaging system includes at least one straight edge 28 to align the tool, the straight edge being perpendicular to a scanning direction of the imaging system when the system is in use.

The tool also includes at least one edge 30 inclined from the perpendicular to the scanning direction, the angle of this skew edge 30 is typically 4-5°. The calibration tool 26 contains a step portion 28 with steps of varying thickness. This step portion or wedge is made of uniform density material such as aluminium or stainless steel, and is used to measure the X-ray intensity for varying thickness of the steps, thus producing a measure of signal versus noise, the common defined Signal to Noise ratio (SNR).

The calibration tool 26 also contains a highly x-ray absorbing segment 29 made up of tungsten or lead bronze, and includes slotted holes 32 perpendicular to the skew edge 30. These slotted holes are positioned to coincide with the centre position of each x-ray camera element. The segment 29 is manufactured from highly x-ray absorbing material so that it is highly x-ray opaque. This segment effective produces two edges a vertical and a horizontal edge, slanted by the skew edge angle. These edges are used to measure the image quality parameters such as the modulation transfer function (MTF) and the notional detective quantum efficiency (notional DQE) for each camera element.

In imaging systems such as the one illustrated above, adjustments have to be made to correct geometric and algorithm parameters in order to optimise the performance of the system. Such adjustments are required during installation and also during routine maintenance. The objective of designing and using a calibration tool is to reduce the time of such installation and maintenance while, at the same time, ensuring a predictable and guaranteed level of imaging performance of the scanning x-ray system.

In such a system, raw image information originates from an array of cameras operating in a time delay integration mode. The raw images of the calibration tool are used to determine the geometric parameters which will subsequently be needed to assemble acceptable images using a set of algorithms.

Thereafter, the calibration tool is used to quantify and track over time the imaging performance of the system, both in the factory and at installation sites. Image quality measurements include at least one of signal to noise ratio (SNR), modulation transfer function (MTF), noise power spectrum (NPS) and notional detective quantum efficiency (notional DQE) for each camera.

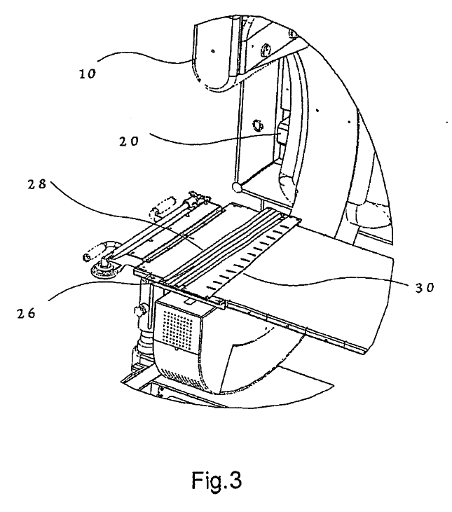

FIG. 3 shows the calibration tool 26 placed in a position relative to the imaging system where an object to be imaged in normal use of the system would be placed.

The measurements are monitored and warnings or errors are recorded to detect and diagnose hardware and system (software) faults or failure.

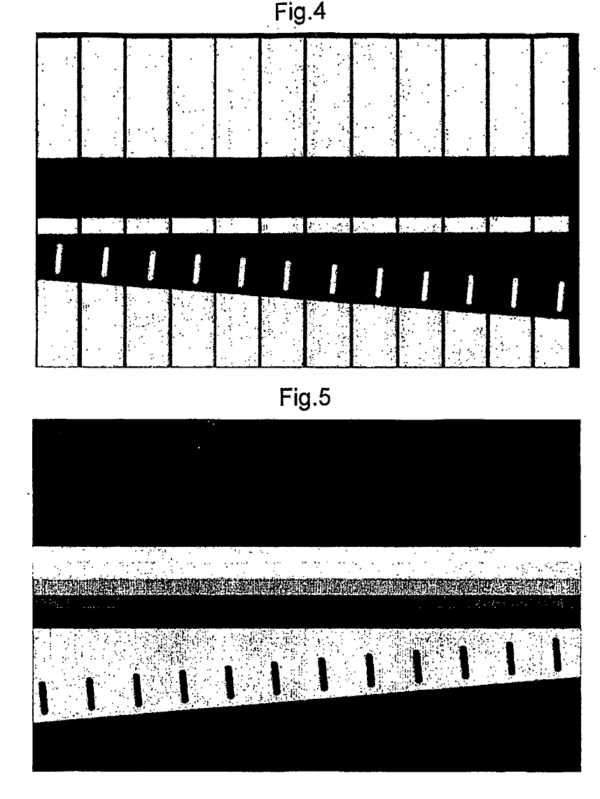

Calibration and image quality evaluation are performed using a raw scan of a calibration tool. The raw image obtained from such a scan is shown in FIG. 4 and a processed image is shown in FIG. 5.

First two geometric corrections are performed, column alignment and column pitch spacing, which includes camera overlapping.

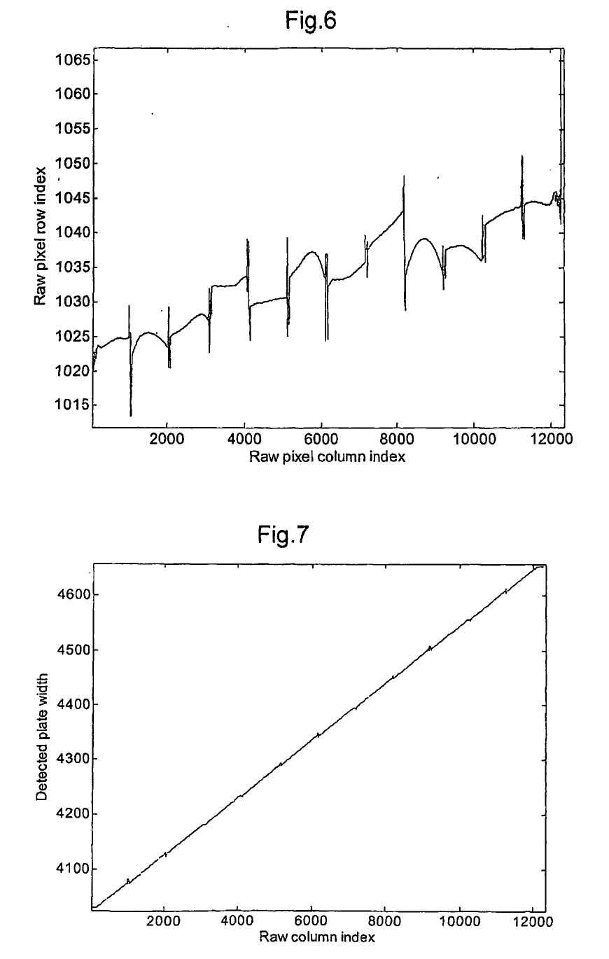

Referring to FIG. 6, column alignment, known as y-alignment, specifies by how much individual columns of pixels must be moved up or down respectively to result in straight edges of the tool appearing horizontal in the final image. This is determined by tracing a contour of the straight edge 27 in the image. A row index position of the edge is detected separately for each column, and a linear interpolation scheme is used to access the shifted pixel appropriately when the final image is constructed.

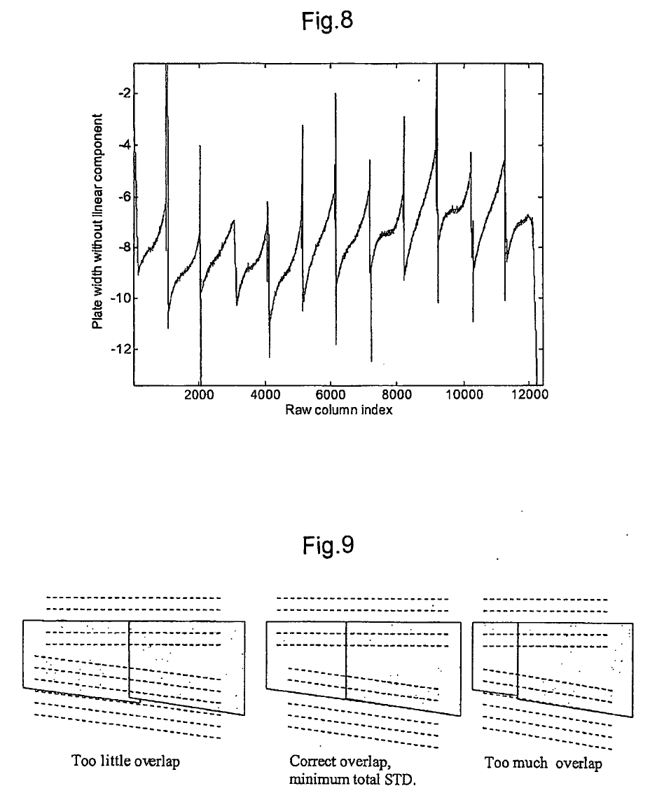

Referring to FIGS. 7 to 9, the pitch detection or pixel spacing is determined by measuring the position of the skew edge 30 in the same way as was carried out for the straight edge for column alignment. The difference between these two edge positions gives the plate width of segment 29. Then, for each adjacent camera pair, an optimisation routine automatically determines the best overlap values, and start and stop positions to be used for each camera which ignore the dark un-illuminated pixels.

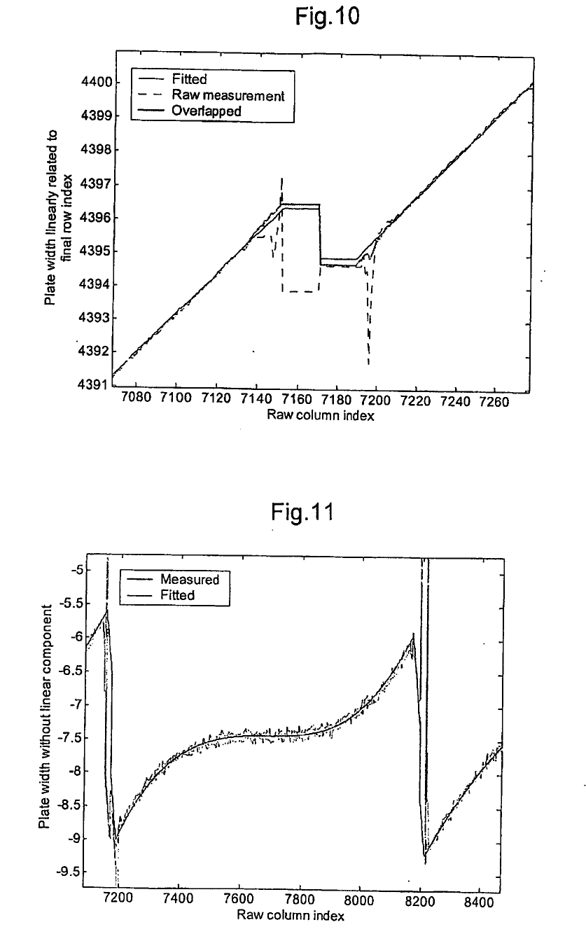

Cost functions are used to average the (separate) standard deviations of the intensities along the dashed lines as shown in FIG. 9. This quantity incorporates the criterion for the visually best overlaps. Once the overlaps are determined, edge information of the adjacent camera can be used to correct or improve poorly detected edge position values at the camera extremes, FIG. 10. Subsequently, a cubic polynomial is fitted to the curve for each camera separately using singular value decomposition to achieve a smooth fitted curve which is then used for pitch correction, FIG. 11.

Once these geometric calibrations calculations have been made, several system parameters can be determined and set for optimal performance and operation. These include y-alignment, pitch correction and gain compensation and saturation compensation parameters.

The software then automatically utilizes the information in the calibration tool image to calculate the image quality parameters mentioned earlier
modulation transfer function (MTF)—using the slot edge and the skew edge profile to determine the MTF for each camera in both the horizontal and the vertical direction. The method use is based on the IEC 62220-1 Specification.
Noise power spectrum—the regions of the image not impaired by the calibration tool are used to determine the noise power spectrum (NPS).
Notional DQE—Using both the above calculation of MTF and NPS, a notional DQE figure is determined for each camera.
SNR—the step wedge is used to determine a SNR figure for each thickness step.

These parameters and measurements are stored and then used to track performance with time.

1. A method of calibrating an imaging system, the method including:
placing a calibration tool in a position relative to the imaging system where an object to be imaged in normal use of the system would be placed;
capturing an image of the calibration tool; and
using the resulting image of the calibration tool to calibrate the imaging system.

2. A method according to claim 1 wherein the resulting image of the calibration tool is stored for future use.

3. A method according to claim 1 wherein the calibration includes column alignment and column pitch spacing.

4. A method according to claim 2 wherein the stored image of the calibration tool is used to test the imaging performance of the imaging system over time.

5. A method according to claim 4 wherein the imaging performance of the system is tested over time by taking images of the calibration tool and comparing these to the stored image of the calibration tool.

6. A method according to claim 4 wherein the image performance of the calibration tool is used to test at least one of the following characteristics of the system: signal to noise ratio (SNR), modulation transfer function (MTF), noise power spectrum (NPS) and notional quantum efficiency (notional DQE).

7. A method according to claim 1 wherein the imaging system is a radiography imaging system.

8. A calibration tool including:
at least one straight edge to align the tool, the straight edge being perpendicular to a scanning direction of an imaging system when the system is in use; and
at least one skew edge inclined from the perpendicular to the scanning direction.

9. A calibration tool according to claim 8 wherein the tool has a portion of varying thickness.

10. A calibration tool according to claim 9 wherein the portion of varying thickness is a step portion.

11. A calibration tool according to claim 10 wherein the tool includes slots or holes perpendicular to the skew edge, and centered over the x-ray detection elements when in use.

12. A calibration tool according to claim 11 wherein the tool is partly made from uniform absorption material and partly made from highly x-ray absorbing material.

13. A calibration tool according to claim 12 wherein the step portion is made from uniform absorption material and a portion near the skew edge is made from x-ray absorbing material.

14. A calibration tool according to claim 13 wherein the step portion has sections of differing thickness perpendicular to an x-ray beam and oriented parallel to the scanning direction of the system, when the tool is in use.
